(19) United States
(12) Patent Application Publication
(10) Pub. No.: US 2024/0079906 A1
(43) Pub. Date: Mar. 7, 2024

(54) POWER PROVIDING DEVICE FOR PORTABLE ELECTRONIC DEVICES

(71) Applicant: Adeeb SOBH, Dearborn, MI (US)

(72) Inventor: Adeeb SOBH, Dearborn, MI (US)

(21) Appl. No.: 18/273,829

(22) PCT Filed: Jan. 21, 2022
(86) PCT No.: PCT/US2022/013238

§ 371 Date: Jul. 24, 2023

Related U.S. Application Data
(60) Provisional application No. 63/140,427, filed on Jan. 22, 2021.

(51) Int. Cl. H02J 50/10; H02J 7/00; H02J 50/90

(52) U.S. Cl. CPC H02J 50/10; H02J 7/0044; H02J 50/90

(57) ABSTRACT

A power providing device for charging portable electronic devices includes a housing configured to removably adhere to at least one of the portable electronic devices, an inductive element built in the housing, and a cable which is wound in the housing, is electrically communicated with the inductive element, and includes an end configured to connect to a power source. The inductive element generates an inductive power for charging at least one of the portable electronic devices. In addition, the housing of the power providing device includes a top plate and a base plate, and further includes a ring received by the top plate and rotatably attached to the housing, and an inductive element inside the housing and/or ring.

### CROSS-REFERENCE TO RELATED APPLICATIONS

This U.S. Application is a § 371 national application from PCT Application No. PCT/US2022/013238, filed Jan. 21, 202, which claims the benefit of priority under 35 U.S.C. § 119 to U.S. Provisional Application No. 63/140,427, filed Jan. 22, 2021, the contents of which are incorporated herein by reference in their entirety.

### FIELD

The present disclosure relates to a power providing device for electronic devices, particularly portable electronic devices.

### BACKGROUND

The statements in this section merely provide background information related to the present disclosure and may not constitute prior art.

Portable electronic devices, such as laptops, cellular telephones and the like, are typically powered by power cells, i.e., rechargeable electrochemical cells often also referred to as batteries (e.g., lithium-ion battery). Depending on the user's use of the portable electronic devices, the batteries of the portable electronic devices may be able to provide power to use the devices for a period of time raging from a couple of hour to more than a day. The reason for this large fluctuation of the length of time to be used with the power provided by its battery is because the users' use of the portable electronic devices and also the physical characteristics of the portable electronic devices such as screen size, processing power, etc., can add numerous and significant variables regarding the length of time.

In order to recharge the power cells, such devices are generally provided with a charger unit for connecting to a power jack socket or a USB port on the device which is wired to contacts with terminals of the cells. However, most users of their portable electronic devices do not carry the appropriate chargers including cables so as to allow for the charging of their portable electronic devices because the chargers including the charging cables are bulky items to carry around. Therefore, the users prefer to rely upon periodic charging, perhaps overnight. However, the users often rely on even more infrequent charging because the batteries often run down at inconvenient times when no charger is available.

### SUMMARY

The present disclosure relates to a power providing device for electronic devices, particularly portable electronic devices for easily charging the portable electronic devices without their charging cables. The present disclosure includes a power providing device having a housing, which is configured to removably adhere to at least one of the portable electronic devices and includes a base plate and a top plate engaged with the base plate, a first inductive element and a second inductive element built in the housing, and a cable which is wound in the housing, is electrically communicated with the first and second inductive elements, and includes an end configured to connect to a power source. The first inductive element and the second inductive element each generate an inductive power for charging at least one of the portable electronic devices. The first inductive element is embedded in the base plate for charging one of the electronic devices which is located in a proximity of the base plate and the second inductive element is embedded in the top plate for charging one of the portable electronic devices which is located in a proximity of the top plate.

According to a further aspect of the present disclosure, the top plate includes a hub formed with a cavity for storing a connector and the second inductive element is formed with a coil wound around the cavity inside the hub. The hub is formed with a separate part which is rotatably engaged with the top plate.

According to another aspect of the present disclosure, the top plate is formed with a channel on an outer surface of the top plate for pivotally resting a ring and the second inductive element is formed with a coil embedded inside the ring such that the second inductive coil is wound along the ring shape.

According to a further aspect of the present disclosure, the housing further includes a bezel engaged with the top and base plates along peripheral edges of the top and base plates to enclose the cable such that the cable is positioned between the bezel and a vertical support of the top plate. The cable extends from the housing and the end of the cable is connected with a connector which plugs into the power source in an extended position of the cable. In addition, the bezel has at least one opening configured to receive and charge at least one earbud.

According to a further aspect of the present disclosure, the housing further includes an energy storage device which is electrically connected with the cable to store power and also provide the power for the portable electronic devices via each of the first and second inductive elements of the housing.

According to a further aspect of the present disclosure, the power providing device includes at least one magnet arranged in the housing for allowing the portable electronic devices to magnetically adhere to the power providing device. A first magnet is formed with a plurality of magnet bars attached to the base plate for coupling with one of the portable electronic devices which is located in a proximity of the base plate. The plurality of magnet bars protruding from the base plate are positioned between a bezel and a vertical support of the top late around peripheral edge of the base plate. The top plate is formed with a C-channel shape including an upper edge and a lower edge extending outward transversely from the vertical support of the top plate. The extended lower edge is formed with a groove encasing the first magnet protruding from the base plate such that the top plate is able to rotate according to the coupled groove and first magnet. In addition, a second magnet is formed with a disk shape arranged inside a hub of the top plate for adhering to one of the portable electronic devices which is located in a proximity of the top plate.

According to another aspect of the present disclosure, the first magnet bars attached to the base plate are positioned at an inner side of the vertical support in a radial direction of the base plate.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of a power providing device in accordance with an exemplary form of the present disclosure, FIG. 1A shows a perspective view of the power providing device without a bezel of FIG. 1, and FIG. 1B shows the bezel of the power providing device of FIG. 1;

FIG. 2 shows an A-A cut-away view of the power providing device of FIG. 1, FIG. 2A shows a ring of the power providing device of FIG. 2, and FIG. 2B shows the A-A cut-away view of the power providing device having different arrangement of a first inductive element of FIG. 2;

FIG. 3 shows a cut-away view of a power providing device in accordance with another exemplary form of the present disclosure;

FIG. 4 shows a perspective view of a power providing device in accordance with another exemplary form of the present disclosure, and FIG. 4A shows a ring of the power providing device of FIG. 4;

FIG. 5 shows the cut-away view of the power providing device having a first and a second magnets of FIG. 1, FIG. 5A shows a top view of the second magnet attached the base plate of the power providing device of FIG. 5, and FIG. 5B shows a detailed view of the cut-away view of the power providing device of FIG. 5;

FIG. 6 shows a cut-away view of a power providing device having a first and a second magnets in accordance with another exemplary form of the present disclosure, and FIG. 6A shows a detailed view of the cut-away view of the power providing device of FIG. 6;

FIG. 7 shows a cut-away view of a power providing device having a first and a second magnets in accordance with another exemplary form of the present disclosure, and FIG. 7A shows a detailed view of the cut-away view of the power providing device of FIG. 7; and

FIG. 8 shows a mobile device removably attached to the power providing device of FIG. 1, FIG. 8A shows an earbuds removably plugged into the power providing device of FIG. 1, FIG. 8B shows a watch removably attached to the power providing device of FIG. 1, and FIG. 8C shows the mobile device, earbuds, and watch removably attached to the power providing device of FIG. 1.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

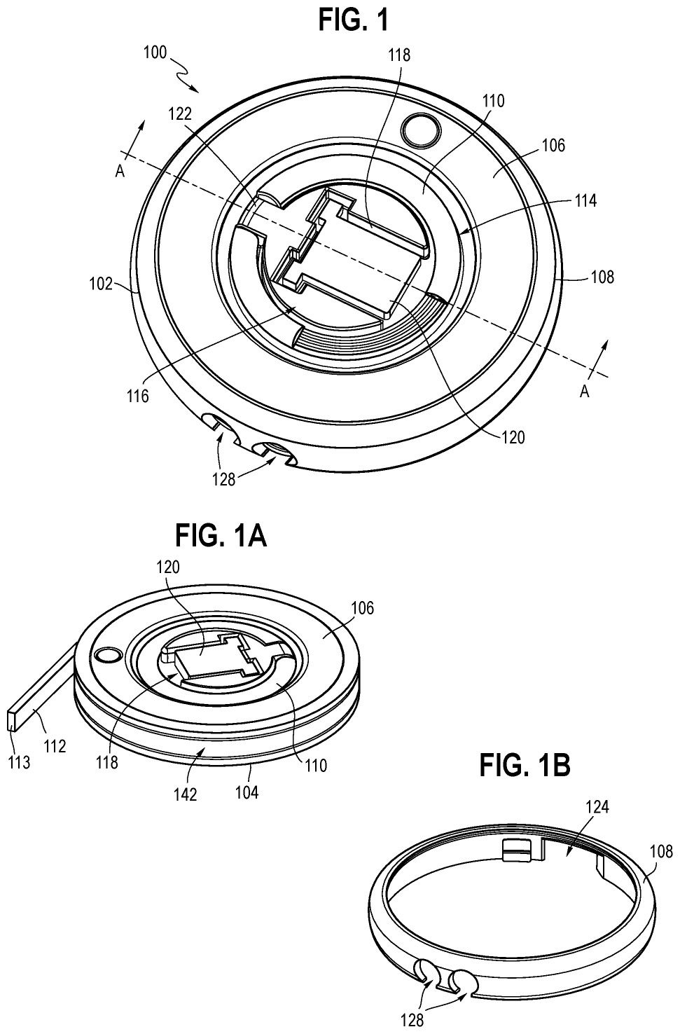

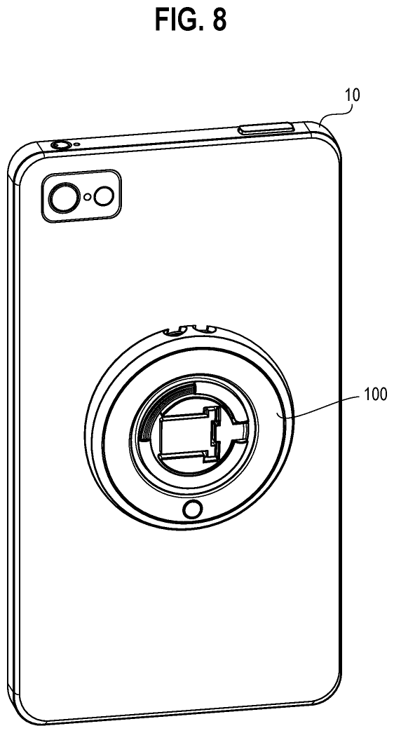

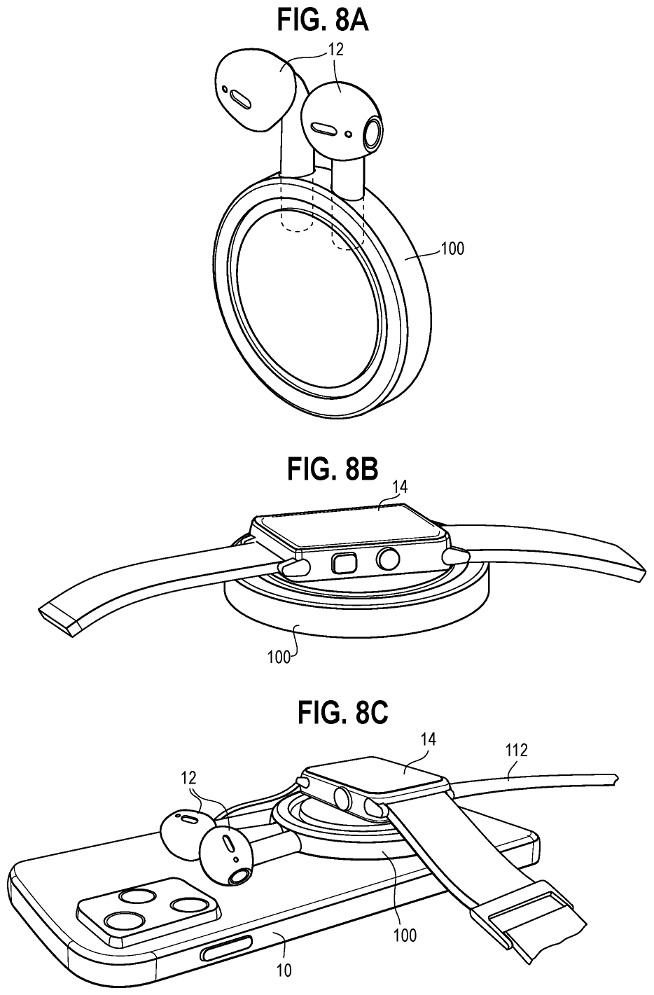

FIGS. 1, 1A, and 1B illustrate a power providing device 100 for charging a portable electronic device such as a mobile phone 10 or electronic accessories including earbuds 12, a watch 14, etc. (see FIGS. 8, 8A, and 8B). It should be understood that while the mobile phone 10, the earbuds 12, and the watch 14 are shown in the examples provided in the specification, the portable electronic devices may be any type of electronic devices, which is able to be carried. As such, instead of the mobile phone 10, the portable electronic devices could be a tablet computer, notebook computer, speaker, music playback devices, portable radio, and the like. Accordingly, as noted above, the portable electronic devices could encompass any one of a number of different electronic devices that are powered by a rechargeable battery.

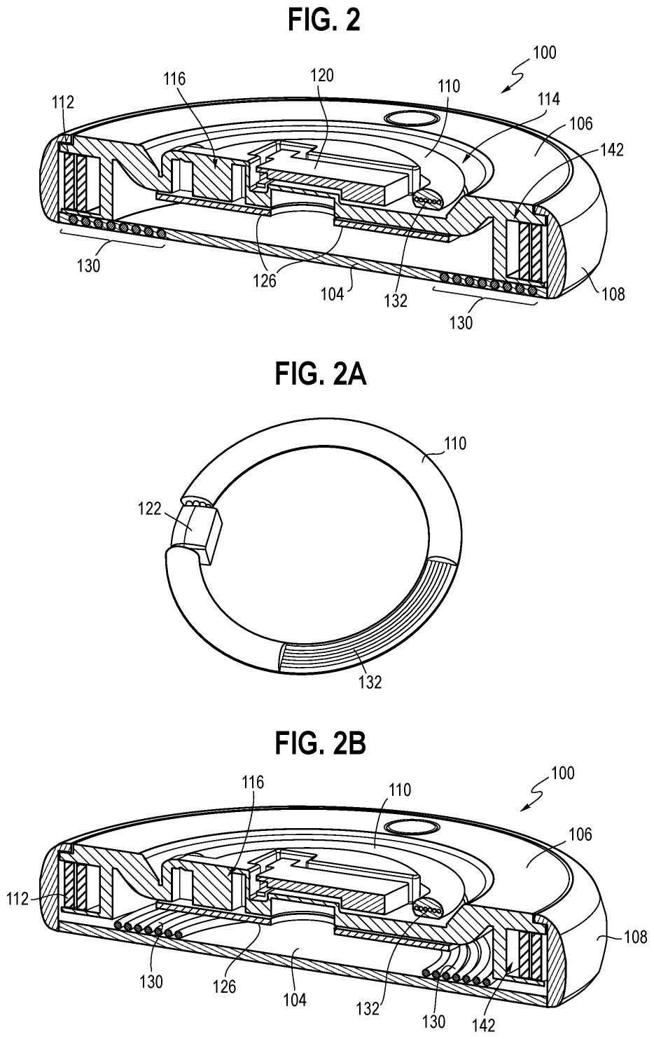

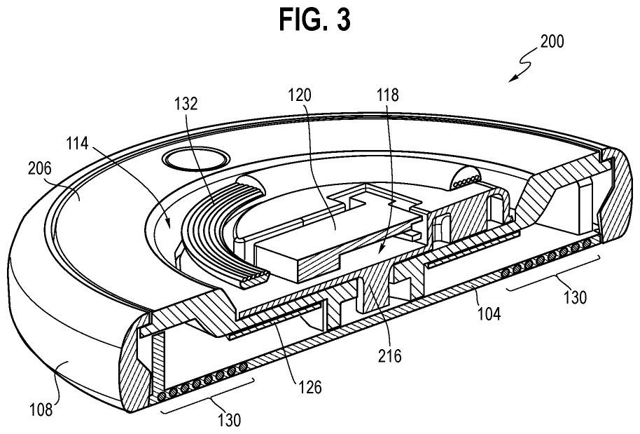

As shown in FIGS. 1, 1A, and 1B, the power providing device 100 is formed with a housing 102 configured to adhere to at least one of the portable electronic devices. The housing 102 generally includes a base plate 104, a top plate 106 engaged with the base plate 104, a bezel 108 coupled with both plates 104 and 106 around the periphery of the both plates 104 and 106, and a ring 110 pivotally connected to the top plate 106 such that the ring 110 swivels up and down. The housing 102 further includes a cable 112 having a first end (not shown) electrically connected to an inductive element (e.g., an inductive coil) and/or an energy storage device 126 inside the housing 102 (see FIGS. 2 and 3) and a second end 113 connected to a power source for transmitting electricity via the cable 112. As shown in an example of FIGS. 1 and 1A, the base plate 104 and the top plate 106 are each formed with a circular shape such that the base plate 104 and the top plate 106 are rotatably engaged with each other.

In FIGS. 1 and 1A, the top plate 106 includes a channel 114 formed on an outer surface of the top plate 106 to rest the ring 110 and a hub 116 formed with a cavity 118 on the outer surface of the top plate 106 for storing a connector 120 such as a Universal Serial Bus (USB). As shown in an example of FIG. 1, furthermore, the cavity 118 is formed with an opened side in the hub 116 of the housing 102. In accordance with other forms of the present disclosure, the connector 120 may be any type of connector for transmitting power, such as connectors commonly found on the mobile phone 10 or other portable electronic devices. This type of the connector may include a USB Type-C connector, a USB mini connector, a micro USB connector, or a Lightning connector. The connector 120 is removably stored in the cavity 118 such that the connector 120 can be removed and connected to the second end 113 of the cable 112 and then connected to the power source to transmit electricity to the inductive element (e.g., inductive coil) and/or the energy storage device (e.g., a power pack when present). When the connector 120 is stored in the cavity 118 on the outer surface of the top plate 106, the ring 110 and/or the connector 120 are generally flush with the outer surface of the top plate 106.

The ring 110 is generally rests within the channel 114 when it is not in use. The ring 110 is specifically attached to the hub 116 of the top plate 106 via the use of a hinge 122, which allows the ring 110 to extend outward from the channel 114 as an extended position. When extended, the ring 110 can act as a support for supporting one of the portable electronic devices, which is adhere to the power providing device 100. In addition, the top plate 106 having the hub 116 is rotatably engaged with the base plate 104 such that the ring 110 attached to the hub 116 is also able to rotate in a circular direction. This allows the ring 110 to not only swivel with respect to the hinge 122 but also rotate itself in a circular direction such that the ring 110 can essentially swivel with respect to anywhere along where the hinge has rotated to. In accordance with other forms of the present disclosure, the ring 110 may form any one of a number of different shapes and does not take necessarily need to form a circular shape as shown in FIGS. 1 and 1A.

In addition, the ring 110 can interact with one or more fingers of a user of the portable electronic device, which adheres to the power providing device 100 so as to allow the electronic device to be gripped better by the user. As noted above, when not used by the user, the ring 110 is stored in a retracted position within the channel 114.

As shown in an example of FIG. 1B, the bezel 108 formed with a ring shape includes a slot 124 through which the cable 112 extends from the housing 102. A peripheral channel 142 (a C-channel) formed in the housing 102, and in the depicted embodiment the peripheral channel 142 is formed in the side of the top plate 106 and enclosed by the bezel 108. The peripheral channel 142 is sized and structured to receive the length of the wound cable 112 therein. When the cable 112 of the power providing device 100 is connected to the power source, the second end 113 extending through the slot 124 is unwound and coupled with the connector 120, which in turn is connected to the power source such that the power providing device 100 can transmit electricity from the power source via the connector 120 connected to the cable 112. Further, the cable 112 is wound back by rotating the top plate 106 and stored inside the channel 142 of the housing 102, and the connector 120 is placed back within the cavity 118 of the top plate 106. Since the ring 110 is rotatable with the top plate 106 about a vertical axis (while still rotatable relative to the top plate 106 via the hinge), the ring 110 can also be used to wind up the cable 112.

As described above, in one approach, the power providing device 100 is adapted to transmit electricity to the inductive element (e.g., the inductive coils 130 and 132). In another approach, the power providing device 100 further includes the energy storage device 126 such as an electronic circuit board and/or a chargeable power pack. The energy storage device 126 such as the electronic circuit board or chargeable power pack can be charged through the cable 112 to provide power to the portable electronic device. In addition, the energy storage device 126 located within the housing 102 can be charged by another methodology such as radiofrequency, solar energy, vibrations, static electricity, and the like. The energy storage device 126 (see FIGS. 2 and 3) is able to store amounts of energy over a period of time for later discharge emergency situations. In addition, as shown in FIG. 1B, the bezel 108 includes a pair of openings 128 receiving a pair of the earbuds 12, which are chargeable. The ends of the earbuds 12 are each plugged into the openings 128 of the bezel 108 in the power providing device 100 to charge the earbuds 12 through an electrical contact with the energy storage device 126 such as the electric circuit board (see FIG. 8A).

FIG. 2 illustrates a cut-away view of the first embodiment of the present disclosure. The housing 102 includes at least one inductive element adapted to provide power for the portable electronic devices which adhere to the power providing device 100. The inductive elements installed in the power providing device 100 are coupled to an external inductive element installed in one of the portable electronic devices, which is located in a proximity of the power providing device 100 so that the external inductive element is electrically connected to the power supply (e.g., the inductive element or energy storage device in the power providing device) in the power providing device 100. Accordingly, the power providing device 100 is configured to charge the portable electronic devices via the coupled inductive elements.

In an exemplary form of FIG. 2, the housing 102 includes two inductive coils such as a first inductive coil 130 and a second inductive coil 132 as the inductive elements. The first inductive coil 130 is embedded in the base plate 104 and is configured to provide power for one of the portable electronic devices which is located in a proximity of the base plate. As shown in FIG. 2, the base plate 106 is formed with a circular shape and the embedded first inductive coil 130 is wound along the circumferential direction of the base plate 106. The first inductive coil 130 can also be located elsewhere, as described further herein. For example, as shown in FIG. 2B, the first inductive coil 130 may be attached to the inner surface of the base plate 104 instead of embedded in the base plate 104. In accordance with other forms of the present disclosure, the first inductive coils 130 embedded in the base plate 106 may be arranged in other patterns such as a regular (parallel to each other) or irregular pattern.

In FIG. 2, as described above, the top plate 106 is formed with the channel 114 for resting the ring 110 and also the hub 116 for attaching the ring 110 via the hinge 122. The second inductive coil 132 is embedded inside the ring 110 and wound inside the ring 110 along with the circular shape of the ring 110. As shown in FIG. 2A, the wound second inductive coil 132 is connected through the hinge 122 and configured to provide power for one of the portable electronic devices which is located in a proximity of the top plate 106. For example, the continued inductive coils inside the ring 110 are routed through an oval shaped ball or ball (not shown), which would sit in the hinge 122, and due to the ball having two brushless contact points that be in contact with the stationary contact points of the hinge 122, the ball moves with the ring 110. In FIGS. 2 and 2A, in one approach, the first and second inductive coils 130 and 132 are each electrically connected to the power pack via the electronic circuit board inside the housing 102 such that the power providing device 100 is able to charge the portable electronic devices which are located in a proximity of the housing 102 via the first and/or second inductive coils 130 and 132.

Referring to FIG. 3, another example of the power providing device 200 is illustrated. Like reference numerals have been utilized to refer to like elements and, as such, the previous description also applies. The exemplary form of FIG. 3 differs from that of FIG. 2 in that a hub 216 is separately engaged with a top plate 206. As shown in FIG. 3, the top plate 206 formed with a circular shape is rotatable relative to the hub 216 such that the top plate 206 and the hub 216 are rotatably engaged, and also are formed with the channel 114 for resting the ring 110 and the cavity 118 for storing the connector 120 like the power providing device 100 of FIG. 2.

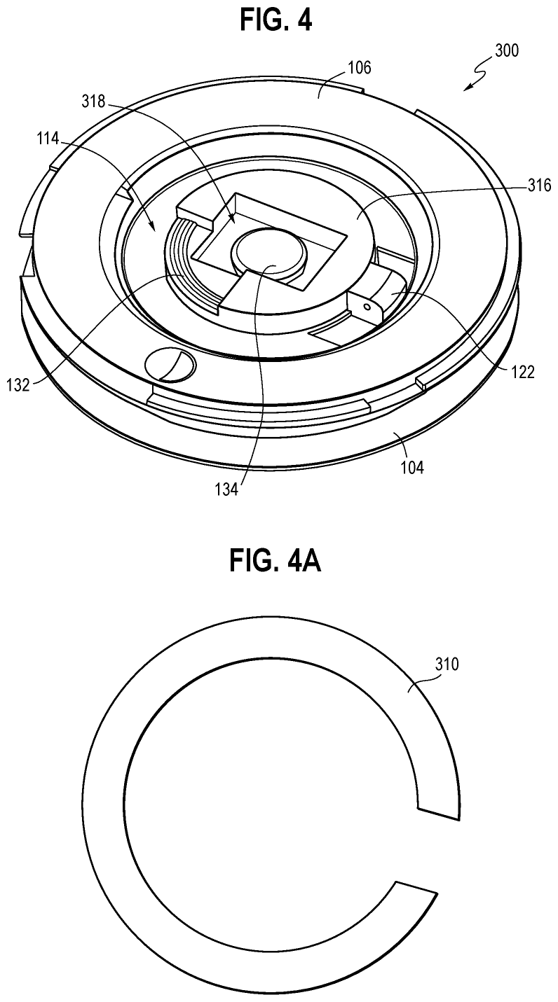

Referring to FIG. 4, another example of the power providing device 300 is illustrated. Like reference numerals have been utilized to refer to like elements and, as such, the previous description also applies. The exemplary form of FIG. 4 differs from that of FIG. 2 in that the second inductive coil 132 is embedded in a hub 316. For example, the hub 316 is formed of a material having a conductivity to transmit the electric power from the embedded second inductive coil 132. As shown in FIG. 4, the hub 316 is formed with a circular shape and also formed with a cavity 318 for storing the connector 120. The cavity 318 is formed with closed sides in the hub 316, and the second inductive coil 132 is wound around the cavity 318 along the circumferential direction of the hub 316. Accordingly, as shown in FIG. 4A, the power providing device 300 includes a ring 310 which is pivotally attached via the hinge 122 without the second inductive coil 132 embedded in the ring 310.

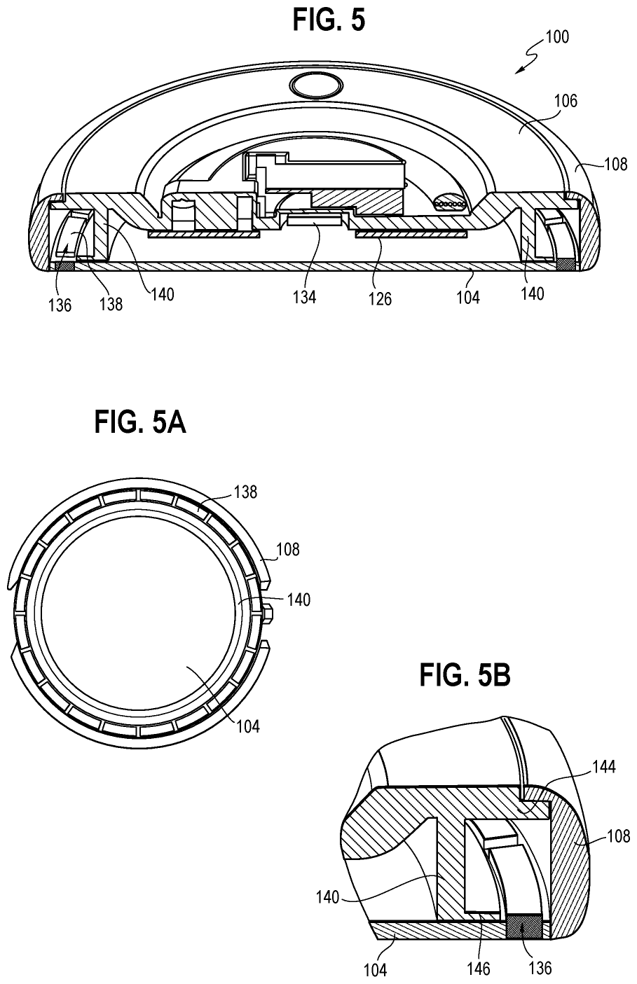

FIG. 5 illustrates the power providing device 100 having at least one magnet arranged in the housing 102 such that the at least one magnet is adapted to allow the power providing device 100 to adhere to the portable electronic devices. The exemplary form of FIG. 5 includes a first magnet 134 and a second magnet 136. The first magnet 134 is located inside the hub 116 and configured to adhere to one of the portable electronic devices which is located in a proximity of the top plate 106. For example, the watch 14 having an inductive coil and a rechargeable battery is able to removably attached to the outer surface of the top plate 106, and also the rechargeable battery of the watch 14 is charged via the coupled inductive coils of the watch 14 and the power providing device 100. (See FIG. 8B). As shown in FIG. 5, the first magnet 134 is formed with a disk shape, but the shape of the first magnet 134 may be provided with different geometric shapes such as a rectangular shape. The first magnet 134 may also be formed by a plurality of magnets arranged in series, e.g. in a generally annular or circular shape or as a block array.

The housing 102 further includes the second magnet 136, which is provided with a plurality of magnet bars 138. The plurality of magnet bars 138 are attached to the inner surface of the base plate 104 and arranged along the peripheral line of the base plate 104 (but can also comprise a single annular magnet). As shown in an example of FIGS. 5, 5A, and 5B, the base plate 104 is formed with a circular shape and the second magnet 136 includes a plurality of magnet bars 138 arranged along the circumferential direction of the base plate 104. Accordingly, in the housing 102 of the power providing device 100, the second magnet 136 is positioned between the bezel 108 and a vertical support 140 of the top plate 106 such that the second magnet 136 is located near the outer edge of the base plate 104.

As shown in FIG. 5, the second magnet 136 arranged in the base plate 104 is adapted to allow the power providing device 100 to adhere to one of the portable electronic devices which is located in a proximity of the base plate 104. For example, the mobile phone 10 having a inductive coil and a rechargeable battery is able to removably attached to the outer surface of the base plate 104 and also the rechargeable battery of the mobile phone 10 is charged via the coupled inductive coils of the mobile phone 10 and the base plate 104 of the housing 102 (see FIG. 8). As such, the mobile phone 10 may be any type of portable electronic device having its inductive coil and rechargeable battery such as a laptop or a tablet.

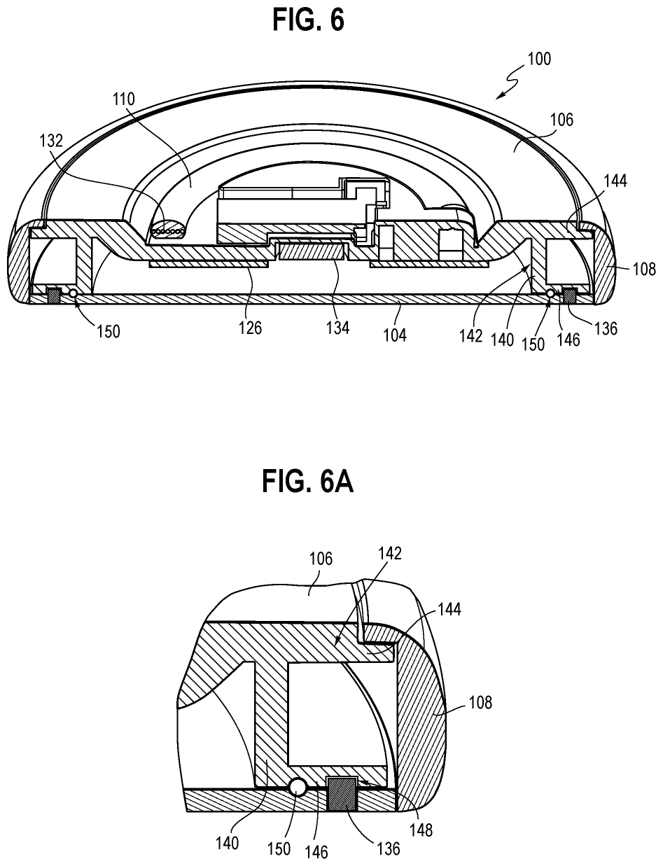

According to an exemplary form of FIGS. 6 and 6A, the top plate 106 is formed with a disk shape and also the C-channel 142 (the peripheral channel) along the circumferential edge of the top plate 106. The C-channel 142 is formed with the vertical support 140 and an upper and a lower edges 144 and 146 extending outward and transversely from the vertical support 140. The upper edge 144 extending from the vertical support 140 is rotatably coupled with the bezel 108 such that the top plate 106 is able to rotate relative to the bezel 108, and the lower edge 146 extending from the vertical support 140 is formed with a groove 148 along the circumferential direction of the top plate 106. The groove 148 of the lower edge 146 encases the second magnet 136 protruding from the base plate 104 and also being arranged between the bezel 108 and the vertical support 140 of the top plate 106. Accordingly, the top plate 106 is able to be rotated relative to the base plate 104 along the coupled second magnet 136 and groove 148 of the lower edge 146. Further, the housing 102 includes a friction reducing element 150 (e.g., a ball bearing) placed between the lower edge 146 and the base plate 104 for facilitating the rotational movement of the top plate 106 relative to the base plate 104. The C-channel is also sized to receive the wound cable 110, as in previous embodiments.

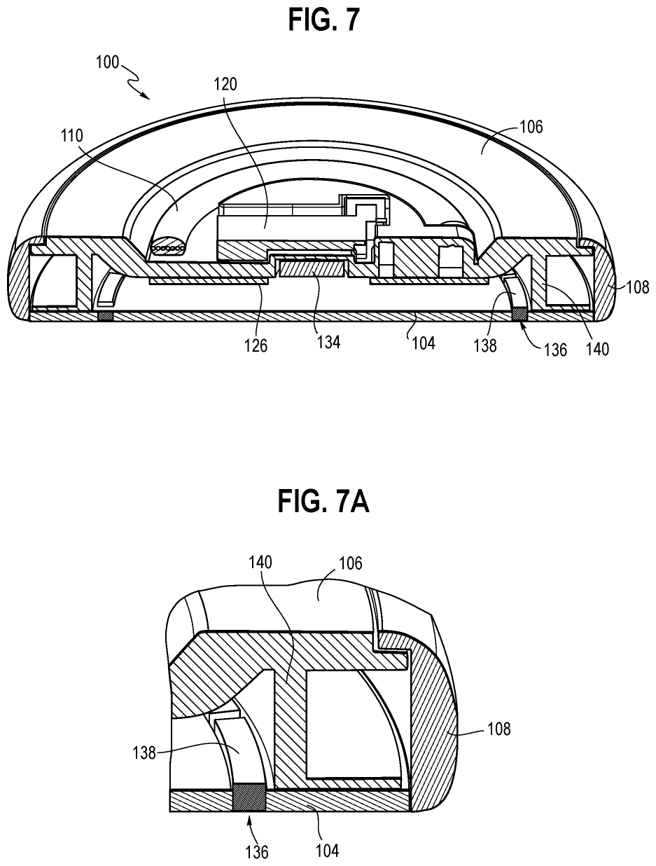

According to an exemplary form of FIGS. 7 and 7A, the second magnet 136 is attached to the base plate 104 along the circumferential direction of the base plate 104 and also arranged in the inner side of the vertical support 140 along the radial direction of the base plate 104. In the exemplary form of FIGS. 5 and 6, as described above, the second magnet 136 is arranged in the outer side of the vertical support 140, which is located between the bezel 108 and the vertical support 140. However, in the exemplary form of FIG. 7, the second magnet 136 is arranged in the inner side of the vertical support 140 of the top plate 106.

According to an example of FIG. 8, the housing 102 of the power providing device 100 is mounted to the mobile device such a mobile phone 10 with any appropriate means for connecting the inductive coil of the mobile device to one of the first and second inductive coils 130 and 132. For example, as described above, the housing 102 is mounted to the mobile phone 10 through the use of the first and second magnets 134 and 136. In accordance with other forms of the present disclosure, the mobile phone 10 may be mounted to the power providing device 100 through an adhesive, air suction material, or other means for mounting the housing 102 to the portable electronic devices.

According to an example of FIG. 8A, as described above, the housing 102 includes the openings 128 receiving one of the earbuds 12 to charge by an electrical contact with the electrical circuit board inside the power providing device 100. The earbuds 12 are designed so that each of the earbuds 12 is plugged into the openings 128 formed in the bezel 108 and held into the openings 128 that causes a press-fit attachment for other active gripping of the earbuds 12. According to an example of FIG. 8B, a watch 14 is magnetically attached to the housing 102 for charging a battery formed inside the watch 14. The inductive coil formed inside the watch 14 is coupled with the first or second inductive coil 130 and 132 embedded in the housing 102 of the power providing device 100 such that the power providing device 100 provides the electric power to charge the battery of the watch 14. In FIG. 8C, for example, the power providing device 100 is removably attached and electrically connected to the mobile phone 10, and the cable 112 extends from the housing 102 and is connected to the power source. In addition, the earbuds 12 are plugged into and electrically connected to the power providing device 100 and the watch 14 is magnetically attached to and also electrically connected to the power providing device 100. Accordingly, as shown in FIG. 8C, the power providing device 100 in the present disclosure is able to provide electric power to the mobile devices including the accessories at the same time.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A power providing device for portable electronic devices, the power providing device comprising:
a housing configured to removably attach to at least one of the portable electronic devices, the housing including a base plate and a top plate engaged with the base plate;
a first inductive element and a second inductive element built into the housing, the first inductive element and the second inductive element each generating an inductive power for charging at least one of the portable electronic devices; and
a cable wound in the housing and electrically communicated with the first and second inductive elements, the cable including an end configured to connect to a power source,
wherein the first inductive element is embedded in the base plate for charging one of the electronic devices which is located in a proximity of the base plate and the second inductive element is embedded in the top plate for charging one of the portable electronic devices which is located in a proximity of the top plate.

2. The power providing device of claim 1, wherein the top plate includes a hub formed with a cavity for storing a connector and the second inductive element is formed with a coil wound around the cavity inside the hub.

3. The power providing device of claim 2, wherein the hub is formed as a separate part which is rotatably engaged with the top plate.

4. The power providing device of claim 1, wherein the top plate is formed with a channel on an outer surface of the top plate for pivotally receiving a ring and the second inductive element is formed with a coil embedded inside the ring such that the second inductive coil is wound along the ring shape.

5. The power providing device of claim 1, wherein the housing further includes a bezel engaged with the top and base plates along peripheral edges of the top and base plates to enclose the cable such that the cable is positioned between the bezel and a vertical support of the top plate.

6. The power providing device of claim 1, wherein the cable extends from the housing and the end of the cable is connected with a connector which plugs into the power source in an extended position of the cable.

7. The power providing device of claim 1, wherein the housing further includes an energy storage device which is electrically connected with the cable to store power and also provide the power for the portable electronic devices via each of the first and second inductive elements of the housing.

8. The power providing device of claim 1, further comprising at least one magnet arranged in the housing for allowing the portable electronic devices to magnetically attach to the power providing device.

9. The power providing device of claim 8, wherein a first magnet is formed with a plurality of magnet bars attached to the base plate for coupling with one of the portable electronic devices which is located in a proximity of the base plate.

10. The power providing device of claim 9, wherein the plurality of magnet bars protrude from the base plate and are positioned between a bezel and a vertical support of the top plate around peripheral edge of the base plate.

11. The power providing device of claim 10, wherein the top plate is formed with a c-channel shape including an upper edge and a lower edge extending outward transversely from the vertical support of the top plate.

12. The power providing device of claim 11, wherein the extended lower edge is formed with a groove encasing the first magnet protruding from the base plate such that the top plate is able to rotate according to the coupled groove and first magnet.

13. The power providing device of claim 9, wherein the plurality of magnet bars attached to the base plate are positioned at an inner side of the vertical support in a radial direction of the base plate.

14. The power providing device of claim 8, wherein a second magnet is formed with a disk shape arranged inside a hub of the top plate for adhering to one of the portable electronic devices which is located in a proximity of the top plate.

15. The power providing device of claim 1, wherein the housing further includes a bezel having at least one opening configured to receive and charge at least one earbud.

16. A power providing device for portable electronic devices, the power providing device comprising:
a housing having a base plate and a top plate engaged with the base plate, the base plate configured to removably attach to at least one of the portable electronic devices;
a ring received by the top plate of the housing and rotatably attached to the housing;
an inductive element built in the ring and configured to generate an inductive power for charging at least one of the portable electronic devices; and
a cable wound in the housing and electrically communicated with the inductive element, the cable including an end configured to connect to a power source.

17. The power providing device of claim 16, wherein the top plate is formed with a channel on an outer surface of the top plate for pivotally receiving the ring.

18. The power providing device of claim 16, wherein the top plate includes a hub formed with a cavity for storing a connector and the second inductive element is formed with a coil wound around the cavity inside the hub.

19. The power providing device of claim 16, wherein the housing further includes a bezel engaged with the top and base plates along peripheral edges of the top and base plates to enclose the cable such that the cable is positioned between the bezel and a vertical support of the top plate.

20. The power providing device of claim 19, wherein the bezel includes at least one opening configured to receive and charge at least one earbud.
